(19) United States
(12) Patent Application Publication
(10) Pub. No.: US 2008/0032617 A1
(43) Pub. Date: Feb. 7, 2008

(54) Modular Motor Vehicle Air-Conditioning Unit

(75) Inventors: Céline Fuentes, Logelbach (FR); Jean-Luc Jesslen, Berwiller (FR); Henri Klein, Colmar (FR); Eric Ludmann, Holtzwihr (FR)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: BEHR FRANCE ROUFFACH SAS, Rouffach (FR)

(21) Appl. No.: 11/662,526

(22) PCT Filed: Sep. 7, 2005
(86) PCT No.: PCT/EP05/09592

§ 371 Date: May 1, 2007

(30) Foreign Application Priority Data
Sep. 10, 2004 (EP) 04292186.6

(51) Int. Cl. B60H 1/00

(52) U.S. Cl. 454/142

(57) ABSTRACT

The invention relates to an air-conditioning unit, in particular, a motor vehicle air-conditioning unit, whereby a part of the housing has a different embodiment for air-conditioning units with differing zones and at least the arrangement of a fan, an evaporator and a heater is the same for the different-zoned air-conditioning units. The housing of the air-conditioning unit may have various embodiments for different versions and/or may be varied by add-on or exchangeable components and, for a multi-zoned embodiment of the air-conditioning unit, a bypass for the floor region is provided in a region of the housing, which diverts from the heater, whereby said bypass is embodied in a region which is redundant in an air-conditioning unit with fewer zones.

The invention relates to a motor vehicle air-conditioning unit, wherein a part of the housing is constructed differently for different-zone air-conditioning units, and at least the arrangement of a fan, an evaporator, and a heater is the same for the different-zone air-conditioning units, wherein the housing of the air-conditioning unit can have various constructions for different versions and/or can be modified by add-on or replacement parts.

From DE 103 45 188 A1, a motor vehicle air-conditioning unit is known, in which for independent control of the temperature of the air blown into the front and rear sitting areas of a passenger compartment, a front air-mixing flap made from a foil flap is formed with an opening through which air passes. The front air-mixing flap opens and closes a front cold air bypass passage and a front air passage of a hot-air exchanger. A wind-up shaft for winding and unwinding the foil flap is arranged in a dividing section, which comes to lie between the front and rear air passage of the hot-air exchanger. A rear air-mixing flap is also formed as a plate flap, which can rotate about a rotational shaft. Such a construction is used to reduce the overall size of the multi-zone motor vehicle air-conditioning unit.

Due to the relatively small quantities of multi-zone air-conditioning units for motor vehicles, their costs are always relatively high, whereas the costs for single-zone air-conditioning units are relatively very low due to very large quantities.

To benefit from the low production costs of 1 and 2 zone air-conditioning units, from DE 100 37 384 A1 a motor vehicle air-conditioning unit is known, in which an additional module in the form of a rear temperature control unit can be attached to a simple base module, wherein the air-conditioning housing of the base module has an air outlet opening that can be closed with a cover part. The rear temperature control unit includes a second heat exchanger for temperature control of the air fed to the rear area. In addition to the front and rear division, a right-left division can also be performed, so that the temperature of the driver and passenger sides can be controlled independently. Here, the second heat exchanger is relatively expensive and also significantly increases the total weight of the air-conditioning unit.

Such air-conditioning units can thus open when desired, in particular, also with reference to the production costs.

The problem of the invention is to make available the most economical motor vehicle air-conditioning unit possible.

This problem is solved by a multi-zone air-conditioning unit with the features of claim 1. Advantageous configurations are the subject matter of the subordinate claims.

According to the invention, an air-conditioning unit, in particular, a motor vehicle air-conditioning unit, is provided, wherein a part of the housing has a different construction for different-zone air-conditioning units and at least the arrangement of a fan, an evaporator, and a heater is the same for the different-zone air-conditioning units, wherein the housing the air-conditioning unit has different constructions for different versions and/or can be changed by add-on or replacement parts, and wherein for a multi-zone construction of the air-conditioning unit, in one region of the housing a bypass, which is led past the heater, is provided for the rear area, wherein the bypass is constructed in an area that is unused in a fewer-zone air-conditioning unit—with reference to the function of the air-conditioning unit. Therefore, because essential areas of the air-conditioning unit have the identical construction for their one-zone or two-zone version, like for their multi-zone version, the production costs, in particular for the multi-zone version, can be reduced due to a plurality of equal parts and a greatly simplified design.

Preferably, at least one mixing flap is provided, which is formed as a butterfly flap. This preferably involves the mixing flap for the rear area, wherein this flap can also be divided in the case of dividing the rear zone into driver-side and passenger-side areas or two mixing flaps could be provided. Preferably, the mixing flaps for the front area also involve butterfly flaps. The butterfly flaps require relatively little control forces, so that the drive motors can be kept small. In addition, two spaced apart openings, for example, the inlet and the outlet to the air channel feeding the air through the heater can be closed—for a corresponding construction.

For the multi-zone air-conditioning unit, preferably a mixing flap for air temperature control for the rear area is provided in the differently constructed part of the housing or in the add-on or replacement part. In particular, dividing the housing allows a simpler assembly of the mixing flap. In the differently constructed part of the housing or in the add-on or replacement part, preferably there are also other flaps, in particular, a defrost flap for defrost mode.

For the multi-zone air-conditioning unit, a mixing flap for air-temperature control for the rear area and a defrost flap for defrost mode, which are coupled to each other, are provided in the differently constructed part of the housing or in the add-on or replacement part. Other couplings are possible.

The bypass preferably runs spatially underneath the heater when the air-conditioning unit is installed in a motor vehicle. This area is normally unused in the case of a one or two-zone, simple basic version of the air-conditioning unit, so that this installation space is available for a multi-zone air-conditioning unit.

Below, the invention is explained in detail using embodiments with reference to the drawing. Shown in the drawing are:

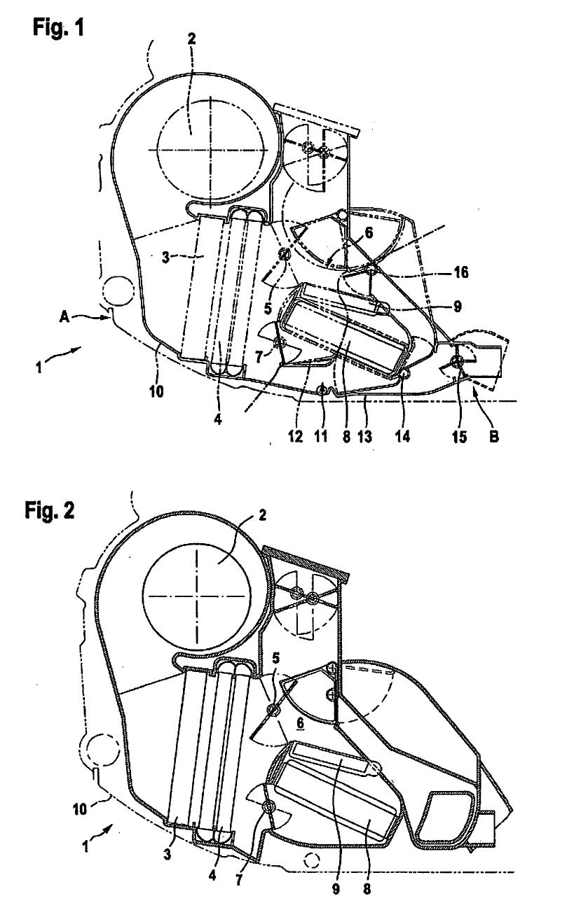

FIG. 1, a schematic section through a three or four-zone motor vehicle air-conditioning unit according to the first embodiment,

FIG. 2, a schematic section through the one or two-zone basic version of the air-conditioning unit of FIG. 1,

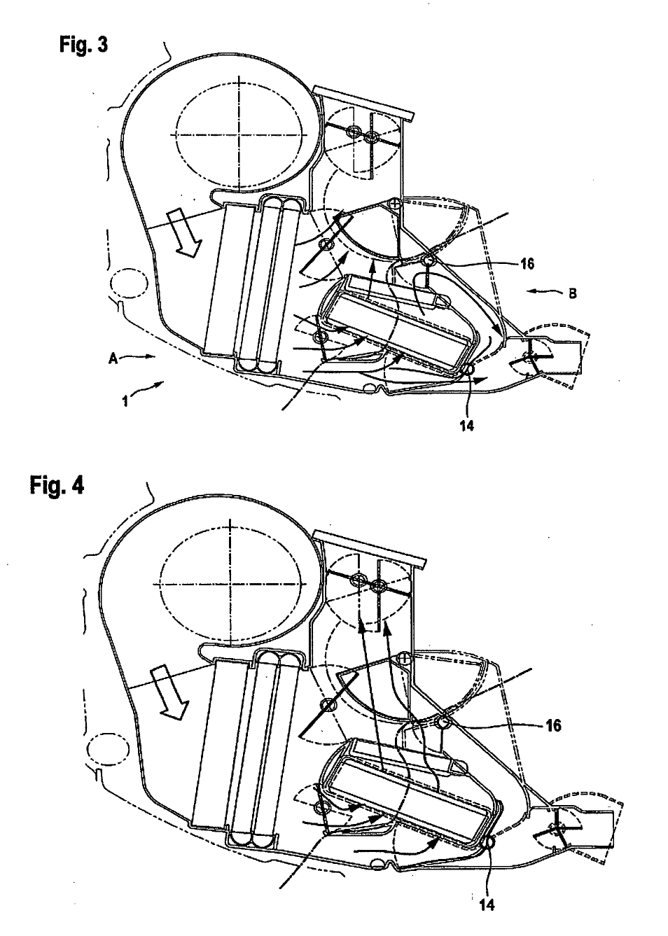

FIG. 3, a section through the air-conditioning unit of FIG. 1 in a normal mixing mode,

FIG. 4, a section through the air-conditioning unit of FIG. 1 in a defrost mode,

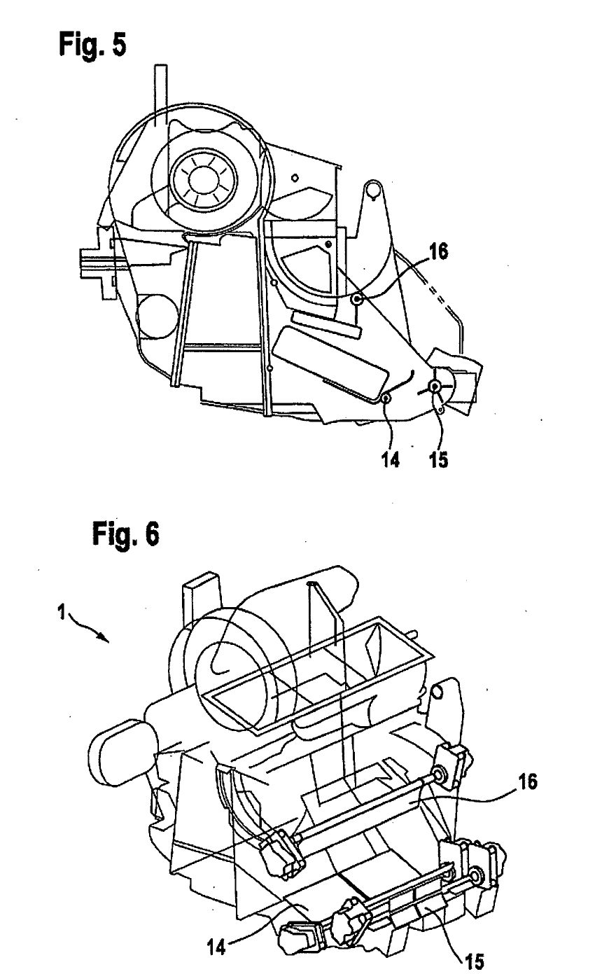

FIG. 5, a sectioned representation of the air-conditioning unit of FIG. 1 with emphasized additional flaps of the multi-zone version,

FIG. 6, a perspective, semi-transparent representation of the air-conditioning unit of FIG. 1 with emphasized additional flaps of the multi-zone version,

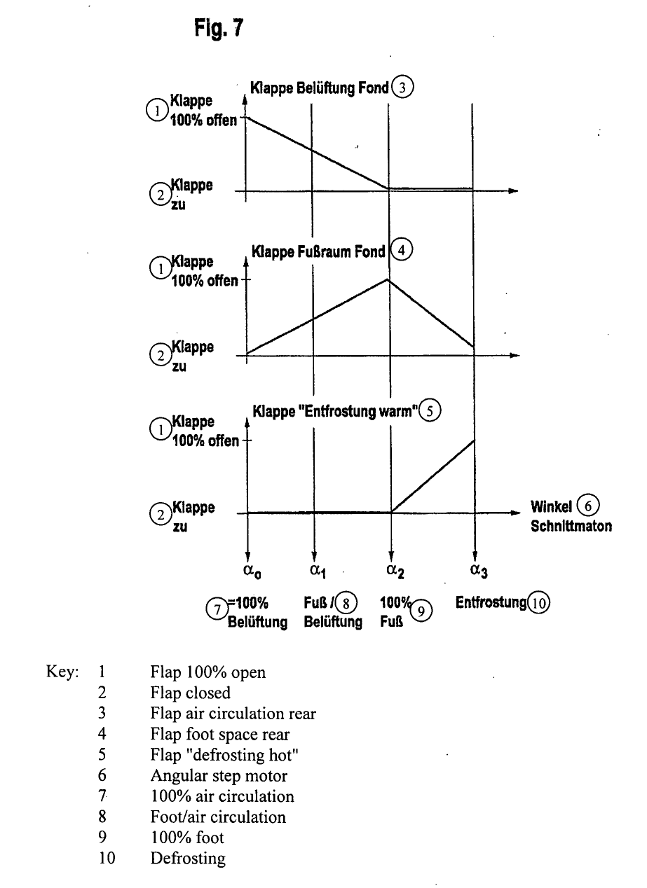

FIG. 7, a representation of the flap opening angle of the air-conditioning unit of FIG. 1 for different operating modes, and

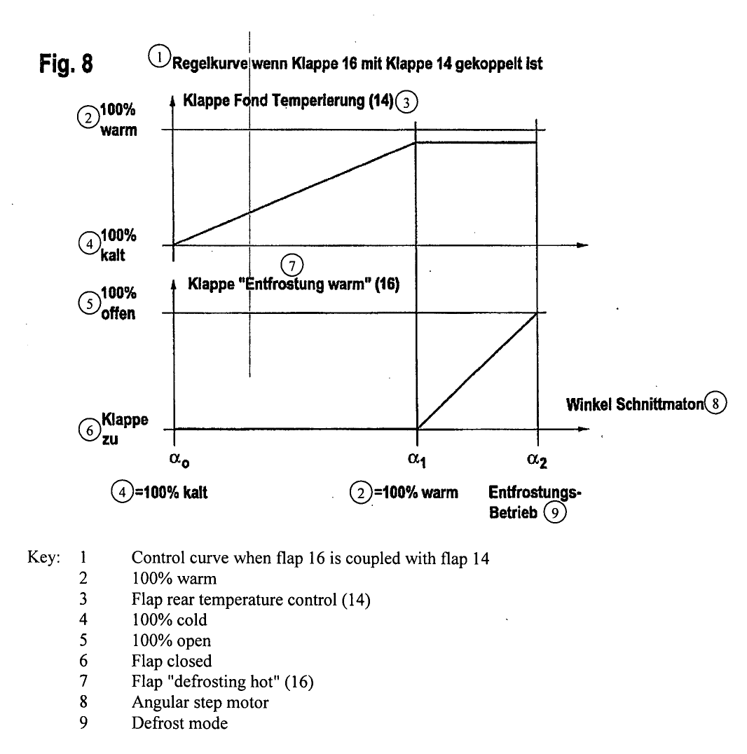

FIG. 8, a representation of the flap opening angle in the case of a coupling of the mixing flap for controlling the air temperature for the rear area and the defrost flap for the defrost mode.

A motor vehicle air-conditioning unit 1 has, as shown in FIG. 2, in its basic version, that is, for a one or two-zone embodiment, a symmetric fan 2 according to the present invention, which draws air from the surroundings and/or from the vehicle interior, a filter 3 downstream of the fan 2, and an evaporator 4, which cools the air coming from the fan 2. The air stream is divided in connection with the evaporator 4. As required, the entire air stream or part of the air stream can be fed directly to the vehicle interior, with a first mixing flap 5 in the form of a butterfly flap being provided for this purpose. The distribution to the individual air vents, through which air is led into the vehicle interior, is then performed in a mixing chamber 6 with the aid of a plurality of flaps. The remaining air stream, controlled by a second mixing flap 7, which is likewise constructed as a butterfly flap, is guided through a heater 8 and an electric auxiliary heater 9, in which this air stream is heated. Then this air stream is likewise led into the mixing chamber 6, where the air streams are mixed as required. The flaps, which control the air stream through the air channels to the vehicle interior, are here constructed so that temperature layering is possible.

For the three or four-zone embodiment, which is shown in FIG. 1, as described previously, at least the core area of the motor vehicle air-conditioning unit 1 has the same construction, that is, among other things, the unit including the fan 2, filter 3, evaporator 4, heater 8, and auxiliary heater 9 is essentially unchanged, that is, apart from the additional separating walls or modified wall profiles, and the same flaps are used, in particular, the mixing flaps 5 and 7. However, in order to enlarge the number of zones, the housing 10 of the air-conditioning unit is somewhat modified, here by replacement parts and additional add-on parts, and additional flaps are provided, in order to control the additional air streams. In FIGS. 3 and 4, each dash-dot line signifies the boundary between the area with the identical construction as the corresponding area A of the basic version and the area B, in which changes have been made.

For example, an area 11 of the housing 10, which is arranged spatially in the installed state underneath the heater 8 and which is unused in the basic version, is divided in two in connection with a changed profile of the housing wall, which is arranged in this area 11 and which is now used as a separating wall 12 and which divides the heater 8 and the auxiliary heater 9 approximately at the middle with regard to the flow profile, and an outer wall 13, which is also provided for the multi-zone version and which is used as an additional air channel through which temperature-controlled air can be fed to the rear area. This air channel is constructed such that when necessary, the cold air can be led under the heater 8 through and past the auxiliary heater 9 (also designated as a bypass below) and/or through the heater 8 and the auxiliary heater 9 (designated as the hot air channel below). In the area, in which the bypass and the hot air channel intersect again, a rear mixing chamber is provided for mixing the cold and hot air streams. The flow profile in FIG. 3 shows the mixing position for normal operation. The control is performed with the aid of a mixing flap 14, which is constructed as a butterfly flap. A vane of the mixing flap 14 closes the air inlet to the heater 8 for the “cold” mode and closes the bypass past the heater 8 and auxiliary heater 9 in the “maximum heat” mode, wherein the vane deflects the air stream to the heater 8. The other vane of the mixing flap 14 closes the end of the air channel through the heater 8 and auxiliary heater 9 in the “cold” operating mode, wherein it leads the air stream flowing through the bypass. In the “maximum heat” operating mode, the vane contacts the wall of the air channel, which separates the flow through the heater 8 and auxiliary heater 9 from the return flow of the heated air (cf. FIG. 4).

Another flap 15 (also designated as distribution flap below) controls the outlet to the different air channels, which lead to the rear area (cf. FIG. 6). Here, several flap elements provided for circulating air to the rear area and the foot space in the rear area, each divided into right and left, are arranged on a shaft. These elements open or close different air channels in a known way. The control of the flap 15 is shown in FIG. 7 in the two upper diagrams.

A flap 16 (also designated as a defrost flap below) is further provided, which allows a merging of the hot front and rear air streams, so that, for defrosting, all of the heater 8 and auxiliary heater 9 output heat to the two air streams separated by the separating wall, and the entire air flow and heating output is made available for deicing or for removing condensation from the front windshield. Because the entire air stream normally fed to the rear area is fed to the air stream of the front area, in this operating mode the temperature of the rear area is not controlled. The flap 16 involves a simple flap, whose pivot axis is arranged in the area of the outer wall of the housing 2, wherein it is arranged at the boundary between the part of the housing 2, which is provided in the basic version and the multi-zone version, and the part of the housing 2, which is provided only in the multi-zone version, in the area of the multi-zone version.

The flap 16 is controlled as a function of the control of the flap 15 according to the diagram at the bottom in FIG. 7. For setting the corresponding angular positions, an angle stepper motor (not shown) is provided, which is connected to the shafts of the flaps 15 and 16 via gears. As can be seen from FIG. 7, in the 100% air circulation operating mode (α₀), only the flap elements of the flap 15 are open, which open or close the air channels for rear air circulation. In the 50% air circulation and 50% foot space operating mode (α₁), all of the flap elements of the flap 15 are opened to approximately 50%. In the 100% foot space operating mode (α₂), only the flap elements of the flap 15 are open, which open or close the air channels to the rear foot space. If the mode is switched to defrost mode, then the flap elements of the flap 15, which are used for controlling rear air circulation, remain closed, the flap elements that are used for regulating the foot space air circulation are closed as a function of the setting, and the flap 16 is opened accordingly until the flap 15 is completely closed and the flap 16 is completely open in the “defrost” end position (α₃), so that all of the air is made available to the front area.

According to one control variant, which is shown in FIG. 8 via the angular position α of the actuator (in this case a step motor), the flaps 14 and 16 are coupled to each other. Here, as can be seen from FIG. 8, in the case of the “100% cold” position of the mixing flap 14 (top curve of FIG. 8) for the rear temperature control, the defrost flap 16 (bottom curve of FIG. 8) are closed (α₀). If the position of the mixing flap 14 changes from “100% cold” through “50% cold/50% hot” to “100% hot,” then the defrost flap 16 remains closed through all positions (α₁). If the actuator is rotated further in the same direction, then the mixing flap 14 remains in the “100% hot” position, but the defrost flap 16 opens in a present linear connection with the angular position of the actuator up to the end position (α₂), in which the mixing flap 14 is in the “100% hot” position and the defrost flap 16 is completely open (100% defrost mode—hot).

According to one variant not shown in the drawing, a specially constructed housing, in which the components, such as fan, filter, evaporator, heater, auxiliary heater are arranged according to the arrangement in the basic version, is provided for the multi-zone motor vehicle air-conditioning unit. Here, the same flaps as for the basic version are used. Furthermore, additional flaps for controlling the air streams to the additional air-conditioning zones are provided. The advantage of a housing exclusively for the basic version and a housing exclusively for the expanded version is that the air channels can be designed for the special case of the application and that additional separating walls do not have to be installed by hand. The static calculations and calculations for the flow profile up to where the air stream is divided and also optionally up to where the cross section of the air streams separated by a separating wall is changed can be essentially eliminated. A corresponding situation applies to the attachment of the actuators for the flaps, which have the same construction in both versions. Furthermore, in both versions essentially the same components can be used. The components that are different, for example, the additional defrost flap in the multi-zone version, are relatively economical, by means of which, also in the case of a different housing, a considerable cost advantage is produced relative to the conventional motor vehicle air-conditioning units.

1-10. (canceled)

1. An air-conditioning unit, in particular, a motor vehicle air-conditioning unit, wherein a part of the housing (10) has a different construction for different-zone air-conditioning units, and at least the arrangement of a fan (2), an evaporator (4), and a heater (8) is the same for different-zone air-conditioning units, wherein the housing (10) of the air-conditioning unit (1) has different constructions for different versions and/or can be changed by add-on or replacement parts, and wherein for a multi-zone construction of the air-conditioning unit (1), a bypass, which leads past the heater (8), for the rear area is provided in the area of the housing (10), wherein the bypass is constructed in an area that is unused for a fewer-zone air-conditioning unit (1).

12. The air-conditioning unit according to claim 11, characterized in that the air-conditioning unit (1) has at least one mixing flap (14), which is constructed as a buttery flap.

13. The air-conditioning unit according to claim 12, characterized in that the mixing flap (14) constructed as a butterfly flap is the mixing flap for the rear area.

14. The air-conditioning unit according to claim 13, characterized in that mixing flaps (5, 7, 14) for the front and rear area are constructed as butterfly flaps.

15. The air-conditioning unit according to claim 11, characterized in that the multi-zone air-conditioning unit (1) includes a mixing flap (14), which is arranged in a differently constructed part of the housing (10) or in the add-on or replacement part and is constructed and arranged for temperature control of the air for the rear area.

16. The air-conditioning unit according to claim 15, characterized in that the multi-zone air-conditioning unit (1) includes flaps (15), which are arranged in the differently constructed part of the housing (10) or in the add-on or replacement part, and are constructed and arranged for distributing air for the air circulation and the foot space in the rear area.

17. The air-conditioning unit according to claim 16, characterized in that the multi-zone air-conditioning unit (1) includes a defrost flap (16), which is arranged in the differently constructed part of the housing (10) or in the add-on or replacement part and which is constructed and arranged to allow the hot rear air stream to be introduced into the hot front air stream in the defrost mode.

18. The air-conditioning unit according to claim 17, characterized in that the multi-zone air-conditioning unit (1) includes flaps (15, 16), which are arranged in the differently constructed part of the housing (10) or in the add-on or replacement part, and are coupled for distributing air for the air circulation and the foot space in the rear area and for the defrost mode.

19. The air-conditioning unit according to claim 11, characterized in that the multi-zone air-conditioning unit (1) includes a mixing flap (14), which is arranged in a differently constructed part of the housing (10) or in the add-on or replacement part and is constructed and arranged for controlling the air temperature for the rear area, and a defrost flap (16) for the defrost mode, wherein these flaps are coupled with each other.

20. The air-conditioning unit according to claim 19, characterized in that the air-conditioning unit (1) is installed in a motor vehicle and the bypass is arranged so that it runs spatially underneath the heater (8).

21. The air-conditioning unit according to claim 12, characterized in that mixing flaps (5, 7, 14) for the front and rear area are constructed as butterfly flaps.

22. The air-conditioning unit according to claim 11, characterized in that the multi-zone air-conditioning unit (1) includes flaps (15), which are arranged in the differently constructed part of the housing (10) or in the add-on or replacement part, and are constructed and arranged for distributing air for the air circulation and the foot space in the rear area.

23. The air-conditioning unit according to claim 22, characterized in that the multi-zone air-conditioning unit (1) includes a defrost flap (16), which is arranged in the differently constructed part of the housing (10) or in the add-on or replacement part and which is constructed and arranged to allow the hot rear air stream to be introduced into the hot front air stream in the defrost mode.

24. The air-condition unit according to claim 23, characterized in that the multi-zone air-conditioning unit (1) includes flaps (15, 16), which are arranged in the differently constructed part of the housing (10) ox in the add-on or replacement part, and are coupled for distributing air for the air circulation and the foot space in the rear area and for the defrost mode.

25. The air-conditioning unit according to claim 11, characterized in that the air-conditioning unit (1) is installed in a motor vehicle and the bypass is arranged so that it runs spatially underneath the heater (8).
